(19) United States
(12) Patent Application Publication
(10) Pub. No.: US 2017/0193478 A1
(43) Pub. Date: Jul. 6, 2017

(54) CHECKOUT KIOSK CONNECTED TO A MOBILE PAYMENT APPLICATION FOR EXPEDITED TRANSACTION PROCESSING

(71) Applicant: PAYPAL, INC., San Jose, CA (US)

(72) Inventors: Deepa Karnad Dhurka, Fremont, CA (US); Yamini Maddirala, San Jose, CA (US); Jacqueline Anderson-Dafaallah, Berkeley, CA (US); BaiChuan Yang, San Jose, CA (US)

(21) Appl. No.: 14/985,021

(22) Filed: Dec. 30, 2015

(51) Int. Cl. G06Q 20/18; G06Q 20/32; G06Q 20/20

(52) U.S. Cl. CPC G06Q 20/18; G06Q 20/204; G06Q 20/3278; G06Q 20/3224

(57) ABSTRACT

There are provided systems and methods for a checkout kiosk connected to a mobile payment application for expedited transaction processing. A user may visit a merchant location for a merchant and select one or more items for purchase from the merchant. A payment provider used to provide payments to the merchant may establish a kiosk at the merchant location. The user may utilize the kiosk to perform transaction processing instead of utilizing a checkout line by entering the items selected for purchase using a mobile device and payment application for the payment provider. A device at the kiosk may provide the payment application to the mobile device, and may assist the user in establishing a payment account with the payment provider. The kiosk may further provide matching of items in the transaction to items in possession of the user to prevent fraud or theft of items.

### TECHNICAL FIELD

The present application generally relates to use of mobile device applications for generating transactions through item input and processing the transaction at connected kiosks, and more specifically to a checkout kiosk connected to a mobile payment application for expedited transaction processing.

### BACKGROUND

A user, such as a consumer, at a merchant location for a merchant may select one or more items for purchase, and may engage in a transaction with the merchant in order to purchase the items. Traditionally, the user may utilize checkout lines at the merchant location to purchase items. At the checkout lines, the user may enter items into a transaction by having a merchant employee scan the items or otherwise enter the items to a point of sale device to generate the transaction. The user may then provide a payment instrument, such as cash, check, or a payment card at the merchant location. However, such transaction processing may take a considerable amount of time, especially where there are multiple other users in a checkout line and/or the transactions are large. Moreover, merchant employees at the point of sale devices may not be trained on payment processing using mobile device applications, or payments made through the mobile device applications may take additional time to establish communication channels and review transactions prior to authorizing payments.

### BRIEF DESCRIPTION OF THE DRAWINGS

FIG. 1 is a block diagram of a networked system suitable for implementing the processes described herein, according to an embodiment;

FIG. 2 is an exemplary environment where a user may utilize a payment provider kiosk with a communication device for expedited transaction processing, according to an embodiment;

FIG. 3 is an exemplary system environment having a communication device connected to one or more devices at a payment provider kiosk for transaction processing using an online payment provider, according to an embodiment;

FIG. 4 is a flowchart for providing a checkout kiosk connected to a mobile payment application for expedited transaction processing, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for providing a checkout kiosk connected to a mobile payment application for expedited transaction processing. Systems suitable for practicing methods of the present disclosure are also provided.

Various merchant locations for merchants may provide one or more products, goods, or services (referred to herein as an “item” or “items”) for sale to users. The merchant locations include physical merchant locations where the users may visit in order to select items for purchase and engage in a transaction to purchase the items. For example, the user may browse items at the merchant location and select one or more items for purchase. In order to purchase items at the merchant location, the merchant may allow the user to provide payment using an online payment provider accessible through a dedicated mobile application and/or website, such as PAYPAL®, VENMO®, or other payment provider service. Thus, the merchant location may provide checkout lines where the user may purchase items by providing payments for one or more selected items for purchase to a merchant employee and/or through a merchant device. However, in addition to the checkout lines or instead of the checkout lines, the merchant location may further provide a kiosk for the payment provider that may perform transaction processing and review to the merchant. The kiosk may or may not include one or more merchant employees and/or kiosk devices, such as a processing device and/or communication interface.

Thus, the user and/or a merchant employee may initiate a transaction using the payment provider kiosk, for example, by entering items to a communication device for the user through scanning of item barcodes, selection of items on an interface of the communication device, entry of item identifiers, entry of item price, or otherwise providing transaction information to the communication device. The communication device may therefore correspond to a mobile device, such as a smart phone, which may include various features and components such as a display, input devices, processor, memory, network interface component for network communications. In various embodiments, the communication device further includes a RFID tag reader, a camera capable of scanning visual codes (e.g., QR or bar codes), and/or other devices for entry of item information to the communication device. The communication device may be used to process a transaction using a mobile application executing on the communication device. For example, after receipt of an identifier for each of the one or more items for purchase and/or selection of the one or more items through an application interface of the mobile application, the communication device may receive a request to generate a transaction for purchase of the selected item(s), for example, through menu selections and/or transaction generation processes in the mobile application. In various embodiments, entry of the item's information and/or selection of the item may function as the request to generate the transaction. The user may pre-install the mobile application for the payment provider prior to visiting the merchant location, and may establish an account with the payment provider using the application, where the application may allow for use of the account during payment processing. The user may then place the items selected for purchase into a cart and continue to the payment provider kiosk instead of a checkout line.

However, in other embodiments, the communication device may not already have the mobile application for the online payment provider installed on the communication device and executable by the communication device. Thus, a device at the kiosk may provide the mobile application to the communication device for installation on the communication device. The communication device may connect to a kiosk device, for example, through a wired or wireless connection, including WiFi, Bluetooth, Bluetooth Low Energy, LTE Direct, near field communications, radio, microwave, infrared, or other wireless communication protocol. In various embodiments, the user may actively establish a connection with the kiosk device, such as through discovery and selection of the kiosk device in a setup interface of the communication device. However, in other embodiments, the kiosk device may be passively discovered and a connection established without user input for the connection. For example, when establishing a connection, the kiosk device may emit a communication signal including an identifier for the kiosk, the merchant, and/or a payment provider service administering the kiosk. When the communication device detects the signal and authenticates the one or more identifiers, both the communication device and the kiosk device may ramp up in power and establish a connection, where the connection may further enable the two devices to pass data back and forth, including an application for the payment provider. The sophistication of the connection may facilitate separate and discrete connections with multiple communication devices should they be within range of the kiosk device. Thus, the kiosk device enables the communication device to establish a connection, authenticate itself, and/or transmit one or more messages to the between the devices.

After a request to establish a transaction is entered by the user, the communication device may be required to determine merchant information for the merchant that is entered to the transaction for processing by the payment provider. If the communication device has previously connected to a device at the payment provider kiosk for the merchant location, the kiosk device may provide the merchant information to the communication device for use in the mobile application, which may be transmitted with the mobile application for downloading and/or installation on the communication device. However, where the communication device has already installed the mobile application and/or the communication device is not in contact with the kiosk device, the communication device may determine the merchant information using a GPS locator of the communication device and determining a merchant at the location of the user detected through the GPS locator of the communication device. The mobile application may also include menu selections and/or input fields for identifying the merchant, for example, using a merchant name, address, or other identifier. However, in other embodiments, the merchant information may be embedded within and/or determined from the identifiers for the items, such as through reading an RFID tag of an item and/or lookup of the identifiers in a database of stored identifiers by the payment provider.

The mobile application may generate the transaction using the items selected for purchase as well as the merchant information. Thus, the transaction may be generated with items for purchase (identified, for example, using the item identifiers for the items), a transaction total including any additional costs (e.g., tax, tip, etc., which may be designated by the user in certain embodiments), and merchant information (e.g., a merchant identifier) identifying an entity to receive payment for the transaction. The mobile application and/or payment provider may further automatically apply any benefits to the transaction and recalculate a total. The benefits may be determined using the merchant information, such as benefits, discounts, and other incentives currently offered by the merchant. Additionally, the benefits may further include any benefits stored to a digital wallet of the user with the payment provider. Once the transaction is generated, the user may request approval for the transaction and processing of the transaction at or nearby the payment provider kiosk at the merchant locations. In various embodiments, the user may instruct the mobile application to perform payment processing and a payment provided to the merchant. However, in other embodiments, the payment processing may occur after approval of the transaction on inspection of items in possession of the user (e.g., placed in the cart of the user at the merchant location).

Thus, the communication device system may provide the transaction and/or transaction history for review to the payment provider kiosk. In various embodiments, the transaction and/or transaction information may be provided to the payment provider kiosk through various communication mechanisms. For example, the communication device may transmit the transaction to the kiosk device at the payment provider kiosk for review over a communication channel (e.g., wired or wireless communications, as discussed herein). The mobile application may also publish the transaction in a limited area, for example, over short range wireless communications, which may be retrieved by the kiosk device on selection of the transaction through an interface of the kiosk device. In further embodiments, the transaction may be communicated to the online payment provider, which may send the transaction back to the kiosk device at the payment provider kiosk. In such embodiments, the user may further identify the payment provider kiosk, such as through an identifier available at the payment provider kiosk. In other embodiments, the communication device may be provided to a merchant or payment provider employee at the kiosk for review of the transaction, which may include display of the transaction on an output display device of the communication device.

The payment provider kiosk may then be used to perform matching of items currently in possession of the user and items selected for purchase and/or purchased by the user for determination of approval of the transaction. In various embodiments, RFID or other electronic tags attached, embedded, or otherwise associated with each item selected for purchase may be matched to items held by the user in a cart of the user, for example, by a scanning of the items or the cart. In other embodiments, a weight of the items held by the user in the cart may be compared to an expected weight for all of the items selected for purchase in the transaction. Still further, visual inspection by a merchant employee or image processing techniques used with a camera at the payment provider kiosk may be used to determine whether the items in possession of the user at the payment provider kiosk match items selected for purchase in the transaction. Where items sold by the merchant may require identification and/or age validation (e.g., prescriptions, tobacco, alcohol, etc.), the user may also provide an identification card or other authentication mechanism at the payment provider kiosk to perform transaction approval.

In certain embodiments, the transaction may be updated and/or additional items added to the transaction. For example, the user may continue shopping after receiving an approval or after requesting a transaction be generated. This may be increasingly likely where items are sold near a checkout or exit area of a merchant location (e.g., magazines sold at the front of a grocery store). Thus, the user may scan or otherwise enter further items into the transaction at the payment provider kiosk. In other embodiments, the payment provider kiosk may be used to enter an update to the transaction and update the transaction with additional items, prices, and/or other transaction information. If payment for the transaction has already been processed, the payment provider kiosk and communication device may be used to generate an additional transaction, and/or request an update of the payment amount processed by the payment provider. Such updates may be transmitted to a device at the payment provider kiosk, which may again check the held items in possession of the user to the selected items for purchase in the transaction, and generate an approval of the transaction when the items match.

Once the transaction is approved, the user may proceed with payment processing where the user has not yet instructed the mobile application to process a payment to the merchant. However, if the transaction has not been approved, the user may be required to edit the transaction and/or the items in possession of the user at the payment provider kiosk until approval may be met. Thus, additional items may be added and/or removed from the transaction where the items do not match the transaction information and/or items detected to be in possession of the user at the payment provider kiosk. The mobile application may be utilized to alter the transaction until approval is reached. In further embodiments, the kiosk device at the payment provider kiosk may also be used to change and/or update the transaction where the transaction is not approved. For example, the kiosk device may be used to alter the transaction and/or add or remove items from the transaction.

The communication device may contact a backend payment processor, such as a credit provider, bank, online payment provider, or other financial institution to perform transaction processing. For example, the merchant may accept Visa®, Discover®, American Express®, PayPal®, and/or Venmo® at a specific merchant location when the user wishes to pay for a transaction. The communication device may provide the transaction information, such as a price or cost of the transaction, with the card identifier and request payment to the merchant, for example, to an account for the merchant. The payment provider may then process a payment to the merchant using the user's payment account, the account of the merchant, and the transaction information. In various embodiments, a payment may not be processed where the payment provider cannot process the transaction, for example, where fraud is detect, if the user has insufficient funds, or other problem occurs during transaction processing. The merchant and/or payment provider may provide a transaction history to the user, such as a physical receipt where the user is required to sign in order to verify and record that the user authorized the transaction. The transaction history may also show a reason for denial or failure of processing the transaction, such as insufficient funds. The merchant and/or payment provider may also provide electronic receipts, which may be sent through text message, email, or other communications to an electronic account or device of the user for storage. Once provided to the user, the user may verify that the user's transaction was approved and payment was processed. Thus, the user may be released to take their items from the merchant location and authorize or provide notification to any merchant employees that the user has paid for the items and may remove the items from the merchant location (e.g., now owns the items).

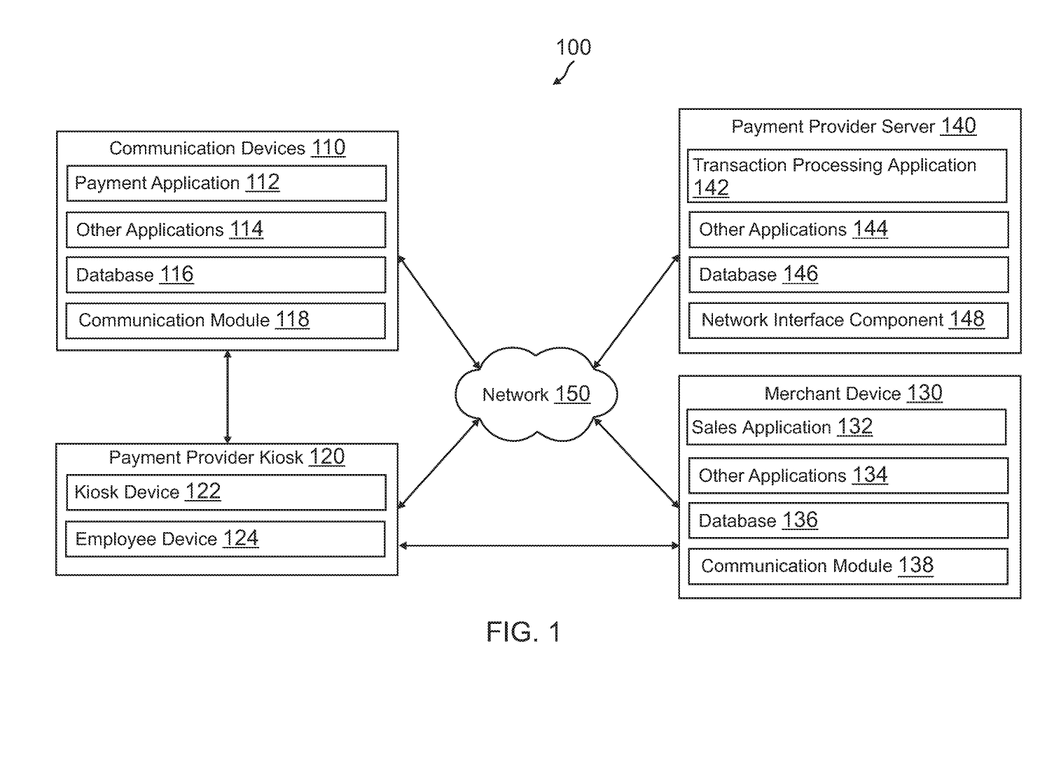

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes the user, a communication device 110, a payment provider kiosk 120, a merchant device 130, and a payment provider server 140 in communication over a network 150. The user may travel to a merchant location associated with merchant device 130 having payment provider kiosk 120 in order to shop for one or more items. While at the merchant location, the user may select one or more items for purchase, which may be entered to a transaction using communication device 110. When the user desires to checkout for the transaction and pay, the user may utilize communication device 110 with payment provider kiosk 120 to provide a payment to merchant device 130. The payment may be processed using payment provider server 140. Payment provider kiosk 120 may be used to determine an approval of the transaction and provide the approval to communication device 110, merchant device 130, and/or payment provider server 140 to allow payment processing to proceed and the user to purchase and remove the items from the merchant location.

Communication device 110, kiosk device 122 and employee device 124 at payment provider kiosk 120, merchant device 130, and payment provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Communication device 110 may be implemented as a communication device that may utilize appropriate hardware and software configured for wired and/or wireless communication with kiosk device 122, employee device 124, merchant device 130, and/or payment provider server 140. For example, in one embodiment, communication device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although a communication device is shown, the communication device may be managed or controlled by any suitable processing device. Although a single communication device is shown, a plurality of communication devices may functions similarly.

Communication device 110 of FIG. 1 contains a payment application 112, other applications 114, a database 116, and a communication module 118. Payment application 112 and other applications 114 may correspond to executable processes, procedures, and/or applications with associated hardware. In other embodiments, communication device 110 may include additional or different modules having specialized hardware and/or software as required.

Payment application 112 may correspond to one or more processes to execute software modules and associated devices of communication device 110 to enter one or more payment instruments or other funding sources for storage in a digital wallet associated with a payment account (e.g., stored and/or serviced by payment provider server 140), access the digital wallet and/or payment account for use, determine a transaction for one or more items selected for purchase, and process the transaction on receiving approval from payment provider kiosk 120. In this regard, payment application 112 may correspond to specialized hardware and/or software utilized by a user of communication device 110 that provides an interface to permit payee users to enter input and other data for payment instruments, for example, through an input device (e.g., touch screen with a graphical user interface displayed by payment application 112, keypad/keyboard, mouse, etc.) and/or through a data capture device (e.g., scanner, magnetic card reader, camera, other optical device, etc.). The payment instruments may correspond to a credit card, debit card, and/or physical card associated with an online account with payment provider server 140. In various embodiments, information for the payment account may also be stored to communication device 110 for use in an offline environment. The payment account accessible through payment application 112 may be used to initiate, receive, and/or process/complete transactions, including transactions processed using payment provider kiosk 120. Once entered, the payment instruments may be communicated to payment provider server 140 over network 150 by payment application 112 for establishment and/or maintenance/update of the payment account and/or entry into the digital wallet. Additional benefits may be stored to the payment account, such as rewards programs, rewards programs membership level, rewards program points, available items in at least one rewards program, cash-back amounts for the at least one rewards program, airline miles, promotional credit, promotional credit rates, promotional discount rate, merchant discounts, merchant discount rates, and merchant coupons.

Payment application 112 may be implemented as a user interface enabling the user to select and provide payment. In various embodiments, payment application 112 may include a general browser application configured to retrieve, present, and communicate information over the Internet (e.g., utilize resources on the World Wide Web) or a private network. For example, payment application 112 may provide a web browser, which may send and receive information over network 150, including retrieving website information (e.g., a website for payment provider server 140) through a URL address provided by payment provider server 140, presenting the website information to the user, and/or communicating information to the website, including payment information for payment through payment provider server 140. However, in other embodiments, payment application 112 may include a dedicated application of payment provider server 140 or other entity (e.g., a merchant), which may be configured to provide payment account services and process financial transactions. Payment application 112 may be installed on communication device 110 prior to the user associated with communication device 110 visiting a merchant location for payment provider kiosk 120 and merchant device 130. However, in other embodiments, payment application 112 may be communicated to communication device 110 using payment provider kiosk 120. Thus, payment application 112 may be installed on communication device 110 at the merchant location, and an account for the user with payment provider server 140 may be established after installation at the merchant location.

In this regard, payment application 112 may be utilized to provide online and real-world payments, for example, through entry or selection of merchant information and/or transaction information and initiating a payment for a transaction using the online account or financial instrument stored to the digital wallet. As discussed herein, payment application 112 may utilize user financial information, such as a credit card, bank account, or other financial account, as a payment instrument when providing payment information. Additionally, payment application 112 may utilize a user account with payment provider, such as payment provider server 140, as the payment instrument. Selection of a payment instrument may occur prior to, at, or after establishment of the financial process. Payment provider server 140 may then use the payment instrument during processing of payment, as discussed herein with respect to payment provider server 140.

For example, payment application 112 may be used to generate a transaction by utilizing one or more of the components, features, and/or processes of communication device 110 to enter item information for one or more items selected for purchase by the user associated with communication device 110. The user may visit a merchant location having payment provider kiosk 120 and merchant device 130 to shop for items for purchase. Once the user finds one or more items the user wishes to purchase, the user may enter item information for the items to payment application 112. The item(s) may be entered through selection of the items in an application interface for payment application 112. Thus, payment application 112 may be associated with the merchant for merchant device 130 or may retrieve merchant information for the merchant that includes items for sale from the merchant. The user may browse item listings and other item information, for example, with an online marketplace. The online marketplace may provide sales of items at the merchant location. However, in other embodiments, the user may utilize other processes to enter the item information. For example, a camera of communication device 110 may be used to image the items and/or an item code (e.g., bar or QR code) in order to enter each item's information. In other embodiments, a code or name for the item may be entered through alphanumeric input to payment application 112. Further, a RFID tag or other short range communication protocol may be used to request and receive item information. Additional information may further be entered for the items, such as a quantity or other sales information.

Once item information is entered to payment application 112, payment application 112 may further require merchant information for the merchant associated with merchant device 130 in order to generate the transaction. For example, the merchant information may designate a payee to receive a payment for the items from the user associated with communication device 110. In various embodiments, the merchant information may be known from the entered item information and/or processed to enter the item information. For example, if the user uses payment application 112 to select a merchant marketplace and one or more items for purchase, payment application 112 may have merchant information from the merchant marketplace. Moreover, an alphanumeric code, a barcode, and/or a QR code, or a readable RFID or other electronic tag, may further be associated with a merchant and merchant information and/or include merchant information. However, other entries of item information may require determination of merchant information, for example, a name and/or quantity of an item. Moreover, the merchant information may be used to determine an amount for each item, a tax rate for the items and/or merchant location, and/or other transaction information.

The merchant information may be entered by the user, such as through entry of a merchant name, address, or other identifier. In other embodiments, the merchant information may be determined using a geo-location of the user. For example, communication device 110 may include a GPS locator or other location detection system, which may determine a location of the user through a location of communication device 110. Communication device 110 may also include mapping, scheduling, and/or other application that may be used to determine a location for the user at a specific time that the user is generating the transaction using the item information. Additionally, communication device 110 may utilize short range wireless communications with another device, such as one or more of kiosk device 122, employee device 124, and/or merchant device 130 to request and/or receive the merchant information.

Once the merchant information is determined, the transaction may be generated by payment application 112 for the items selected for purchase by the user from the merchant associated with merchant device 130. The transaction may include a payment to the merchant for a total amount for the items and any additional costs (e.g., tax, tip, service charges, etc.). Payment application 112 may automatically apply any discounts available for the transaction to the transaction. Payment application 112 may determine discounts and other benefits from the merchant information, for example, through available discounts from the merchant (e.g., current sales, rebates, discounts, etc.). Additionally, payment application 112 may utilize any discounts stored to the user's digital wallet with payment provider server 140 when applying discounts. Such discounts may be benefits directly associated with the user in the user's digital wallet, and may include loyalty information, gift cards, and/or specifically held coupons or benefits.

In order to proceed with the transaction, processing payment application 112 may be required to get approval from payment provider kiosk 120. Payment application 112 may provide the transaction (e.g., details of the transaction) to one or more devices for payment provider kiosk 120, for example, kiosk device 122 and/or employee device 124. Payment application 112 may communicate the transaction to the devices using short range wireless communications with the device and/or wired communications. In other embodiments, payment application 112 may publish the transaction to a general area discoverable using short range wireless communications. The transaction may also be communicated to merchant device 130 and/or payment provider server 140 over a network connection, which may then be communicated back to a device at payment provider kiosk 120. In other embodiments, the transaction may be output to an application interface of communication device 110 for review at payment provider kiosk 120.

If payment provider kiosk 120 notices errors in the transaction, for example, if the items in the transaction do not match the items in possession of the user at payment provider kiosk 120, payment application may be used to edit the transaction and/or alert the user of the errors to change the items the user currently possesses. Thus, payment application 112 may be utilized to provide updates to the transaction. Once approval is received, the transaction may be communicated to payment provider server 140 for processing. Thus, payment provider kiosk 120 may be utilized to provide payment for a transaction, as discussed herein. Payment application 112 may be utilized to view the results of payment, for example, using transaction histories, dispute resolution processes, and other post-transaction process. Such transaction histories may be retrievable from payment provider server 140, for example, as a statement for a financial instrument (e.g., monthly billing or use statement) or as individual transactions. The results of a payment and/or transaction may also be communicated to communication device 110 from payment provider kiosk 120, as discussed herein. Payment application 112 may then be used to provide or display a receipt for proof of purchase of the items in the transaction.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. In various embodiments, other applications 114 may include financial applications, such as banking, online payments, money transfer, or other applications. Other applications 114 may also include other location detection applications, which may be used to determine a location for the user, such as a mapping, compass, and/or GPS application, which can include a specialized GPS receiver that obtains location information for communication device 110 and processes the location information to determine a location of communication device 110 and the user. Other applications may include social networking applications, media viewing, and/or merchant applications. Other applications may be used to communicate a URL address to a payer or other user (e.g., payer devices 120).

Other applications 114 may also include connection applications, which may be used to connect with devices at payment provider kiosk 120, for example, using short range wireless communications with kiosk device 122 and/or employee device 124. Thus, other applications 114 may be used to send data to and receive data from payment provider kiosk 120. Other applications 114 may include device interfaces and other display modules that may receive input from the user and/or output information to the user. For example, other applications 114 may contain software programs, executable by a processor, including a graphical user interface (GUI) configured to provide an interface to the user. Other applications 114 may therefore use devices of communication device 110, such as display devices, including GUI's capable of displaying information to users and other output devices, including speakers. Communication device 110 may include input devices, including touch screens. Communication device 110 may include a sensor or other component used to collect the current information associated with the user, such as an input device, a camera, a microphone, an accelerometer, a motion detector, an environmental sensor, and/or a biometric sensor.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with payment application 112 and/or other applications 114, identifiers associated with hardware of communication device 110, or other appropriate identifiers, such as identifiers used for payment/user/device authentication or identification, which may be communicated as identifying communication device 110 to payment provider server 140. Where applicable, information used by payment application 112 may be stored to database 116 (e.g., payment account information and/or transaction information, such as item and merchant information and an approval of the transaction). Such information may further include transaction histories for transactions processed using payment provider kiosk 120.

Communication device 110 includes at least one communication module 118 adapted to communicate with kiosk device 122, employee device 124, merchant device 130, and/or payment provider server 140. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices using short range communications, such as Bluetooth Low Energy, LTE Direct, WiFi, radio frequency, infrared, Bluetooth, and near field communications.

Payment provider kiosk 120 may correspond to a physical kiosk, such as a stand, cubicle, or other structure at a merchant location for a merchant associated with merchant device 130. Payment provider kiosk 120 may be associated with payment provider server 140 by advertising payment processes provided by payment provider server 140 and providing payment processing using payment provider server 140. In this regard, payment provider kiosk 120 may include one or more employees associated with merchant device 130 and/or payment provider server 140, or may be automated for processing using the devices at payment provider kiosk 120. Thus, payment provider kiosk 120 includes one or more of kiosk device 122 and/or employee device 124. Payment provider kiosk 120 may be located within the merchant location where one or more users may visit to checkout and pay for a transaction using the processes provided by payment provider kiosk 120 with payment provider server 140. For example, payment provider kiosk 120 may be located near an exit or checkout area and provide transaction processing on behalf of the merchant with users at the merchant location.

Payment provider kiosk 120 of FIG. 1 contains a kiosk device 122 and an employee device 124. Kiosk device 122 and employee device 124 may correspond to devices having executable processes, procedures, and/or applications with associated hardware. In other embodiments, payment provider kiosk 120 may include additional or different devices as required.

Kiosk device 122 and employee device 124 may correspond to one or more devices used to provide payment processing by reviewing a transaction and held items in possession of a user in order to provide approval for the transaction. In this regard, kiosk device 122 and employee device 124 may be located at payment provider kiosk 120 and receive transaction information generated by payment application 112, as discussed herein. The transaction information includes a transaction between a user associated with communication device 110 and a merchant associated with merchant device 130. The transaction information may be reviewed using kiosk device 122 and/or employee device 124 to approve the transaction based on the items selected for purchase in the transaction and items currently in possession of the user for the transaction at payment provider kiosk 120. For example, kiosk device 122 may include one or more input devices to determine the held items in possession of the user. Kiosk device 122 may correspond to an automated device configured to detect items held by a user and compare the items to items selected for purchase in a received transaction. For example, kiosk device 122 may include a barcode, QR code, or other code reader to detect one or more items in possession of the user through scanning a code. In other embodiments, kiosk device 122 may include an RFID tag reader or other reader configured to detected tags using short range wireless communications. Kiosk device 122 may also include a scale or other weight detection component, which may detect a weight of the items held by the user. Similarly, employee device 124 may include one or more of the aforementioned components to detect held items in possession of the user. However, employee device 124 may be utilized by a merchant or payment provider employee at payment provider kiosk 120. In this regard, employee device 124 may also display the transaction information, which may be visually inspected and compared to held items of the user at payment provider kiosk 120.

Kiosk device 122 and/or employee device 124 may compare held items in possession of the user at payment provider kiosk 120 to the items listed in the transaction between the user and the merchant for purchase by the user. Where the held items and the selected items for purchase do not match, kiosk device 122 and/or employee device 124 may alert an employee at payment provider kiosk 120 and/or the user, for example, through payment application 112 of communication device 110. Kiosk device 122 and/or employee device 124 may request that the transaction be changed to include additional items in possession of the user but not in the transaction or delete items in the transaction that are not in possession of the user. Kiosk device 122 and/or employee device 124 may also prevent transaction processing and may not provide a receipt or other transaction result to allow the user to purchase the items and remove the items from the merchant location. However, where the items match, kiosk device 122 and/or employee device 124 may approve the transaction and provide a communication to communication device 110 of the approval. The approval may be used to initiate transaction processing and/or provide a process to allow the user to purchase the items and/or remove the items from the merchant location.

Kiosk device 122 and employee device 124 may include a database stored to a non-transitory memory and may store identifiers for use during processing of a transaction. Moreover, the databases may include transaction information for a received transaction, as well as item information for items in possession of a user. Kiosk device 122 and employee device 124 may also contain one or more communication modules, which may be utilized to exchange data between communication device 110, merchant device 130, and/or payment provider server 140. The communication module(s) may communicate with nearby devices using short range communications, such as Bluetooth Low Energy, LTE Direct, WiFi, radio frequency, infrared, Bluetooth, and near field communications. In various embodiments, kiosk device 122 and employee device 124 may further provide wired and/or network communications.

Merchant device 130 may be maintained, for example, by a merchant corresponding to a merchant location, which may offer one or more items for purchase through the merchant location In this regard, merchant device 130 include one or more processing applications which may be configured to interact with communication device 110, kiosk device 122 and/or employee device 124 at payment provider kiosk 120, and/or payment provider server 140 to facilitate generation of a transaction and payment to the merchant for the transaction. In various embodiments, merchant device 130 may also correspond to devices offering online sale of items, which the user may purchase while at a merchant location. However, in other embodiments, merchant device 130 may be maintained by or include any merchant, including merchants that offer offline sales of items through a merchant location. Merchant device may be implemented as a personal computer (PC), a smart phone, laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Moreover, in various embodiments, one or more of the applications, processes, and/or features discussed below in reference to merchant device 130 may be included in one or more merchant servers. Moreover, although only a single merchant device is references herein, a plurality of merchant devices may function similarly.

Merchant device 130 of FIG. 1 contains a sales application 132, other applications 134, a database 136, and a communication module 138. Sales application 132 and other applications 134 may correspond to processes, procedures, and/or applications executable by a hardware processor, for example, a software program. In other embodiments, merchant device 130 may include additional or different modules having specialized hardware and/or software as required.

Sales application 132 may correspond to one or more processes to execute modules and associated specialized hardware of merchant device 130 that provides a sales interface and/or online marketplace to sell one or more items offered by a merchant (not shown) associated with merchant device 130, and further provide payment processes for a transaction to purchase the items for sale from the merchant corresponding to merchant device 130. In this regard, sales application 132 may correspond to specialized hardware and/or software of merchant device 130 to provide a convenient interface to permit a merchant offer items for sale. For example, sales application 132 may be implemented as an application offering items for sale that may be utilized by the merchant or a merchant employee to enter items selected by a user to a transaction, determine a price for the transaction, and initiate a checkout and payment process for the transaction. However, in order to provide transaction processing through payment provider kiosk 120, sales application 132 may provide item information for use by payment application 112 of communication device 110, kiosk device 122, and/or employee device 124. Thus, data for sales application 132 may be accessed by communication device 110 to select the items for sale to the user associated with communication device 110. Merchant device 130 may be local to a physical merchant location and receive payments for transactions processed by payment provider server 140.

Sales application 132 may include information for a price for the item, a discount for the item, a price change for the item, and/or other incentives for items and/or with the merchant corresponding to merchant device 130 (e.g., rebates, payments, etc.). The sales data and other item data may be retrievable by communication device 110 and/or payment provider server 140, such as requestable through an API call, retrievable from a database, and/or scraped from an online resource. The information may be updated periodically or continuously, such as in real time as information for the item(s) for sale changes. Sales application 132 may also include merchant information, such as a merchant name or other identifier, merchant location, payment mechanisms accepted by the merchant, and other relevant data for a merchant. Sales application 132 may receive transaction information and the result of transaction processing from payment provider kiosk 120, which may be utilized to receive a payment using a payment processing system, such as payment provider server 140. In such embodiments, once a payment is processed for a transaction, for example, by having payment provided to the merchant account, notification of payment (or failure, for example, where there are insufficient user funds) may be sent to sales application 132. The payment may be made by payment provider server 140 on behalf of the user associated with communication device 110. Sales application 132 may then receive the results of the transaction processing, and complete the transaction with the user, for example, by providing a receipt for the transaction and/or allowing the user to purchase the items and remove the items from the merchant location.

Merchant device 130 includes other applications 134 as may be desired in particular embodiments to provide features to merchant device 130. For example, other applications 134 may include security applications for implementing client-side security features, programmatic client applications for interfacing with appropriate application programming interfaces (APIs) over network 150, or other types of applications. Other applications 134 may also include email, texting, voice and IM applications that allow a user to send and receive emails, calls, texts, and other notifications through network 150. In various embodiments, other applications 134 may include financial applications, such as banking, online payments, money transfer, or other applications associated with payment provider server 140. Other applications 134 may contain software programs, executable by a processor, including a graphical user interface (GUI) configured to provide an interface to the user.

Merchant device 130 may further include database 136 which may include, for example, identifiers such as operating system registry entries, cookies associated with sales application 132 and/or other applications 134, identifiers associated with hardware of merchant device 130, or other appropriate identifiers, such as identifiers used for payment/user/device authentication or identification. Identifiers in database 136 may be used by a payment/credit provider, such as payment provider server 140, to associate merchant device 130 with a particular account maintained by the payment/credit provider. Merchant, item, sales, and/or benefit information for items sold by the merchant associated with merchant device 130 may be stored to database 136. Database 136 may further include transaction information and/or results, including transaction histories.

Merchant device 130 includes at least one communication module 138 adapted to communicate with communication device 110, payment provider kiosk 120, and/or payment provider server 140. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Payment provider server 140 may be maintained, for example, by an online service provider, which may provide payment and financial services to a user. In this regard, payment provider server 140 includes one or more processing applications which may be configured to interact with communication device 110, kiosk device 122 and employee device 124 at payment provider kiosk 120, merchant device 130, and/or another device/server to provide transaction processing, account services, and other financial processes. In one example, payment provider server 140 may be provided by PAYPAL®, Inc. of San Jose, Calif., USA. However, in other embodiments, payment provider server 140 may be maintained by or include another type of service provider, which may provide connection services to a plurality of users.

Payment provider server 140 of FIG. 1 includes a transaction processing application 142, other applications 144, a database 146, and a network interface component 148. Transaction processing application 142 and other applications 144 may correspond to executable processes, procedures, and/or applications with associated hardware. In other embodiments, payment provider server 140 may include additional or different modules having specialized hardware and/or software as required.

Transaction processing application 142 may correspond to one or more processes to execute software modules and associated specialized hardware of payment provider server 140 to provide payment services to merchants and users, for example though a payment account and/or payment instruments. In this regard, transaction processing application 142 may correspond to specialized hardware and/or software to provide payment services and payment accounts, including digital wallets storing payment instruments. The payment services may allow for a payment to the merchant by a user through a payment instrument, including a credit/debit card, banking account, payment account with payment provider server 140, and/or other financial instrument. In order to establish a payment account for a merchant and/or user to send and receive payments, transaction processing application 142 may receive information requesting establishment of the payment account. The information may include user personal and/or financial information. Additionally the information may include a login, account name, password, PIN, or other account creation information. The merchant/user may provide a name, address, social security number, or other personal information necessary to establish the account and/or effectuate payments through the account. Transaction processing application 142 may further allow the merchant/user to service and maintain the payment account, for example, by adding and removing payment instruments. In various embodiments, a payment application (e.g., payment application 112) and payment process using payment provider kiosk 120 may be associated with payment provider kiosk 120 for transaction processing.

Transaction processing application 142 may be used to provide a payment for an item to a merchant, for example, between communication device 110 and merchant device 130. In this regard, transaction processing application 142 may receive the transaction after approval of the transaction to be processed is generated and provided by payment provider kiosk 120, for example, on inspection of held items in possession of a user to selected items for purchase by the user in the transaction. The transaction may be received from communication device 110, payment provider kiosk 120, and/or merchant device 130. The transaction may include a transaction amount, and may designate a payment instrument. Transaction processing application 142 may debit an account of the user automatically and provide the payment to an account of the merchant. Transaction processing application 142 may also be used to provide transaction histories for processed transactions. Based on the transaction processing, a receipt may be provided to merchant device 130 and/or generated by merchant device 130 after receiving acknowledgement and/or proof of payment by the user to the merchant through transaction processing application 142.

In various embodiments, payment provider server 140 includes other applications 144 as may be desired in particular embodiments to provide features to payment provider server 134. For example, other applications 144 may include security applications for implementing server-side security features, programmatic client applications for interfacing with appropriate application programming interfaces (APIs) over network 150, or other types of applications. Other applications 144 may contain software programs, executable by a processor, including a graphical user interface (GUI), configured to provide an interface to the user when accessing payment provider server 140, where the user or other users may interact with the GUI to more easily view and communicate information. In various embodiments, other applications 144 may include connection and/or communication applications, which may be utilized to communicate information to over network 150.

Additionally, payment provider server 140 includes database 146. As previously discussed, the user and/or the merchant corresponding to merchant device 130 may establish one or more digital wallets and/or payment accounts with payment provider server 140. Digital wallets and/or payment accounts in database 146 may include user information, such as name, address, birthdate, payment instruments/funding sources, additional user financial information, user preferences, and/or other desired user data. Users may link to their respective digital wallets and/or payment accounts through an account, user, merchant, and/or device identifier. Thus, when an identifier is transmitted to payment provider server 140, e.g., from communication device 110, one or more digital wallets and/or payment accounts belonging to the users may be found. Database 146 may also store transaction information and transaction processing results.

In various embodiments, payment provider server 140 includes at least one network interface component 148 adapted to communicate communication device 110, kiosk device 122 and employee device 124 at payment provider kiosk 120, and/or merchant device 130 over network 150. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

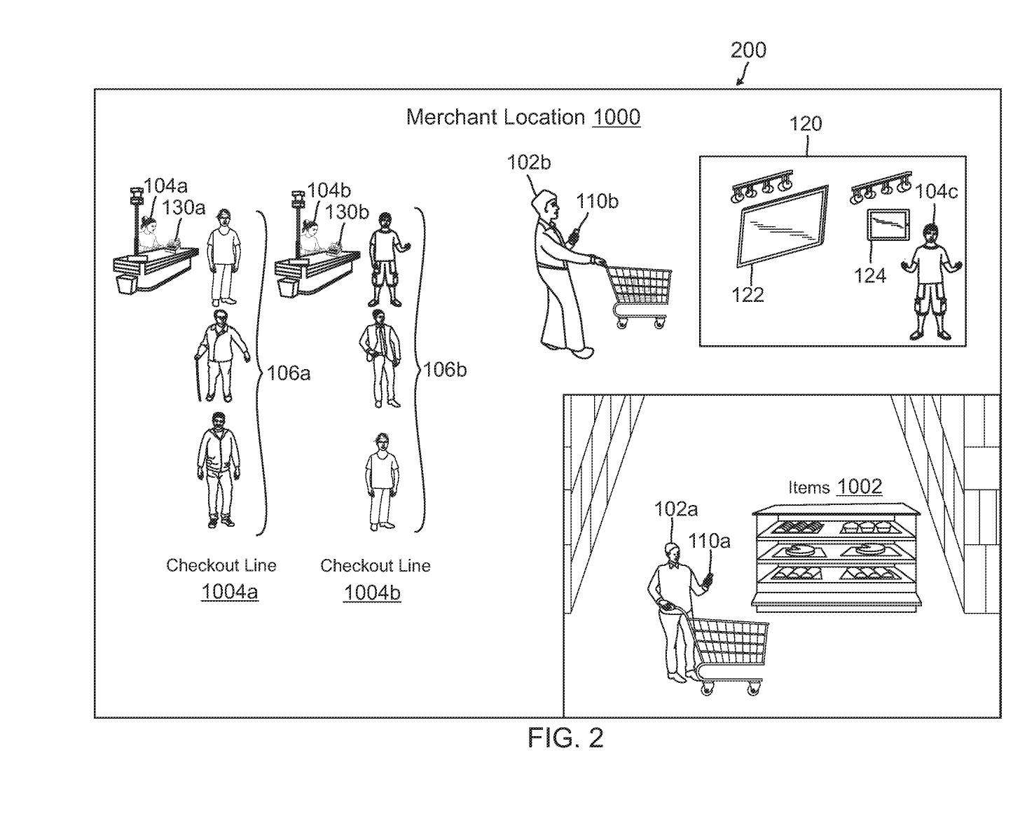

FIG. 2 is an exemplary environment where a user may utilize a payment provider kiosk with a communication device for expedited transaction processing, according to an embodiment. Environment 200 of FIG. 2 includes a communication device 110a and a communication device 110b corresponding generally to communication device 110 in system 100 of FIG. 1. Environment 200 further includes a merchant device 130a and a merchant device 130b corresponding generally to merchant device 130 in system 100 of FIG. 1. Additionally, environment 200 includes payment provider kiosk 120 having kiosk device 122 and employee device 124 described in reference to FIG. 1.

A merchant location 1000 in environment 200 may include traditional payment processing systems. In this regard, users 106a and user 106b may visit merchant location 1000 to purchase one or more items. For example, one or more of users 106a and 106b may shop for items 1002 found at merchant location 1000. Once one or more of items 1002 are selected by users 106a and 106b are selected for purchase, user 106a and 106b may visit a checkout line 1004b and/or a checkout line 1004b to pay for the selected items. Thus, users 106a are shown in checkout line 1004a and user 106b are shown in checkout line 1004b. In order to perform payment processing and purchase items, users 106a may wait in checkout line 1004a for merchant employee 104a to enter items to merchant device 130a for a transaction, and then provide a payment instrument to pay for the transaction. Similarly, users 106b may wait in checkout line 1004b for merchant employee 104b to enter items to merchant device 130b for a transaction, and then provide a payment instrument to pay for the transaction. However, as shown at merchant location 1000, users 106a and 106b are required to wait on two (or more) merchant employees to purchase items, thereby limiting throughput of users during checkout processing to the merchant employees available and the amount of time each transaction takes to be entered and processed.

Thus, merchant location 1000 further includes payment provider kiosk 120 to provide transaction processing to users at merchant location 1000. For example, a user 102a may shop for items 1002 and select one or more items for purchase. While shopping items 1002, user 102a may utilize communication device 110a to enter each item's information to communication device 110a, provide merchant information for merchant location 1000, and cause a transaction to be generate. User 102a may have an application used for transaction generate already installed on communication device 110a. In other embodiments, user 102a may connect communication device 110a to one or more of kiosk device 122 and/or employee device 124 to download and install the application. Additionally, user 102a may retrieve the merchant information using kiosk device 122 and/or employee device 124. Once user 102a is ready to purchase the items selected from items 1002 and entered to communicate device 102a, user 102a may bypass lines by moving within distance of payment provider kiosk 120 to allow for transaction processing using communication device 110a.

Thus, a user 102b is shown as located at payment provider kiosk 120 to receive approval of user 102b's transaction and begin payment and checkout processes to purchase the items. In various embodiments, kiosk device 122 may be used to determine an approval of user 102b's transaction generated using communication device 110b. For example, communication device 110b may communicate the transaction to kiosk device 122, which may approve the transaction after matching the items selected for purchase in the transaction to items currently in possession of user 102b while user 102b is at payment provider kiosk 120. Thus, communication device 110b may communicate with kiosk device 122. In other embodiments, communication device 110b may communicate with employee device 124, where an employee 104c (e.g., a merchant employee or an employee of the payment provider) may provide the approval through review of the user's items and the transaction displayed on employee device 124. In various embodiments, payment may be provided prior to approval, where removal of items from merchant location 1000 is only permitted by user 102b one approval is met at payment provider kiosk 120. Once approval has been provided to communication device 110b, user 102b may utilize communication device 110b to perform payment processing and/or checkout and purchase/removal of items using communication device 110b.

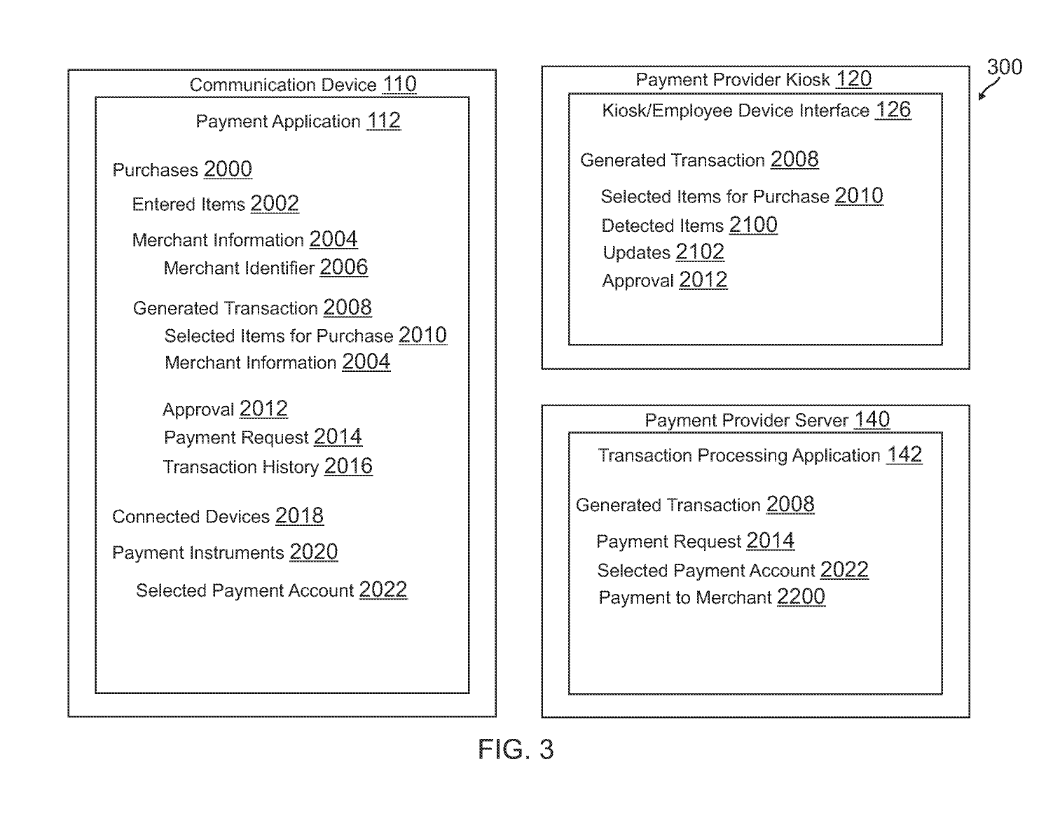

FIG. 3 is an exemplary system environment having a communication device connected to one or more devices at a payment provider kiosk for transaction processing using an online payment provider, according to an embodiment. Environment 300 of FIG. 3 includes a communication device 110, a payment provider kiosk 120, and a payment provider server 140 corresponding generally to communication device 110, payment provider kiosk 120, and payment provider server 140, respectively, of FIG. 1.

Communication device 110 executes payment application 112 corresponding generally to the specialized hardware and/or software modules and processes described in reference to FIG. 1. In this regard, payment application 112 includes purchases 2000, which may correspond to potential transaction for a user of communication device 110. In this regard, purchases 2000 include entered items 2002, which may correspond to items entered to payment application 112, for example, through menu selections, scanning, and/or code entering of information for the items. Purchases 2000 further include merchant information 2004 for a merchant corresponding to one or more of entered items 2002, which may include a merchant identifier 2006 to identify the merchant. Using entered items 2002 and merchant information 2004, a generated transaction 2008 may be determined. Generated transaction 2008 includes selected items for purchase 2010, merchant information 2004, as well as additional received information and processes, such as an approval 2012, a payment request 2014 for generated transaction 2008, and a transaction history 2016 documenting completion of generated transaction 2008. Payment application 112 may include further information, including connected devices 2018 for communication of information, as well as available payment instruments 2020 for payment request 2014, such as a selected payment account 2022.

Payment provider kiosk includes a device displaying an interface, such as kiosk/employee device interface 126 corresponding generally to the specialized hardware and/or software modules and processes described in reference to kiosk device 122 or employee device 124 of FIG. 1. In this regard, kiosk/employee device interface 126 may include information used to approve a transaction. For example, generated transaction 2008 may be communication to the device providing kiosk/employee device interface 126 at payment provider kiosk 120. Kiosk/employee device interface 126 includes selected items for purchase 2010 for use in matching to detected items 2100. Updates 2102 may also be used to determine changes to selected items for purchase 2010. If selected items for purchase 2010 match detected items 2100, the device corresponding to kiosk/employee device interface 126 may provide approval 2012 to communication device 110.

Payment provider server 140 executes transaction processing application 142 corresponding generally to the specialized hardware and/or software modules and processes described in reference to FIG. 1. In this regard, transaction processing application 142 includes information for use in transaction processing of a transaction and providing payment to a recipient party, such as a merchant in a consumer-merchant transaction. Thus, transaction processing application 142 includes information for generated transaction 2008 from communication device 110. In order to process generated transaction 2008, transaction processing application 142 may utilize payment request 2014 received with generated transaction 2008, as well as a selected payment account 2022. Using selected payment account 2022, a payment to merchant 2200 may be provided for the merchant identified using merchant information 2004 for generated transaction 2008.

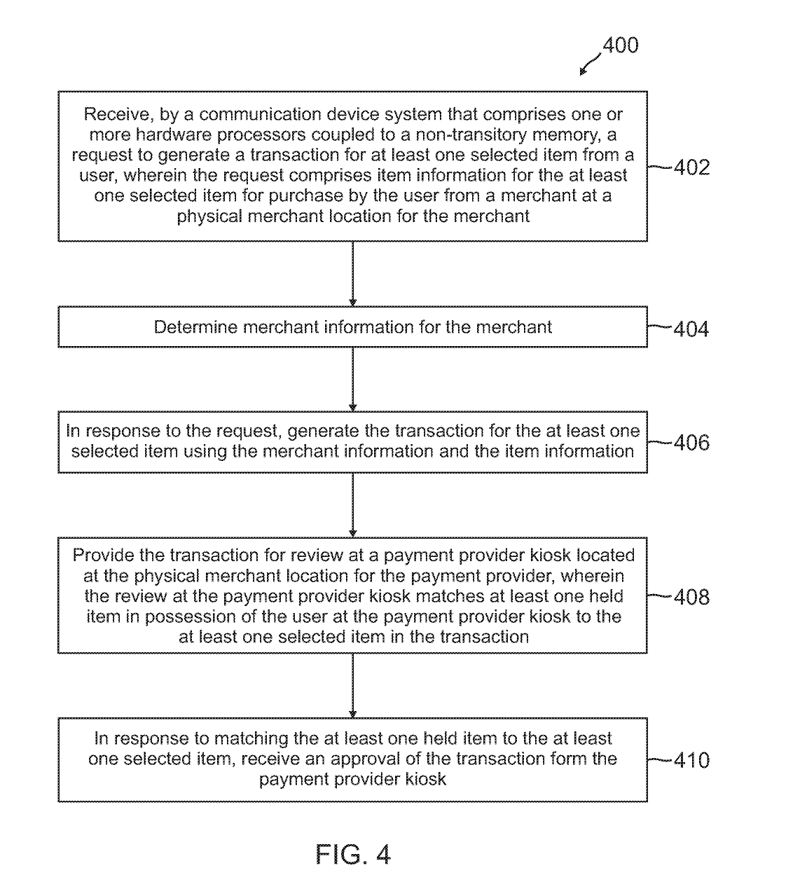

FIG. 4 is a flowchart for providing a checkout kiosk connected to a mobile payment application for expedited transaction processing, according to an embodiment. Note that one or more steps, processes, and methods described herein may be omitted, performed in a different sequence, or combined as desired or appropriate.

At step 402, a request to generate a transaction for at least one selected item from a user is received, by a communication device system that comprises one or more hardware processors coupled to a non-transitory memory, wherein the request comprises item information for the at least one selected item for purchase by the user from a merchant at a physical merchant location for the merchant. The at least one selected item for purchase may be selected through scanning a code for each of the at least one selected item using a camera of communication device system. Additionally, the at least one selected item for purchase may be selected through a menu selection of each of the at least one selected item through a mobile application executing on the communication device system, or the at least one selected item for purchase may selected through entry of an item identifier for each of the at least one selected item, wherein the item identifier is associated with the at least one selected item at the merchant location.

Merchant information for the merchant is determined, at step 404. The determining the merchant information may comprise receiving a merchant identifier for the merchant from the user and retrieving the merchant information using the merchant identifier. The determining the merchant information may also comprise determining a geo-location for the user using a GPS locator for the communication device system and retrieving the merchant information using the geo-location of the user. In response to the request, the transaction is generated for the at least one selected item using the merchant information and the item information, at step 406. In various embodiments, at least one discount for the transaction is determined using merchant discount information for the merchant and user benefits stored to a digital wallet of the user with the payment provider. Thus, the at least one discount to the transaction is applied prior to payment processing for the transaction at the payment provider kiosk.

At step 408, the transaction is provided for review at a payment provider kiosk located at the physical merchant location for the payment provider, wherein the review at the payment provider kiosk matches at least one held item in possession of the user at the payment provider kiosk to the at least one selected item in the transaction. For example, the communication device system may provide the transaction to a device at the payment provider kiosk using short range wireless communications comprising one of near field communication, Bluetooth communication, Bluetooth Low Energy (BLE) communication, WiFi communication, and LTE Direct communication. In such embodiments, the determining the merchant information comprises retrieving the merchant information from the device at the payment provider using the short range wireless communications. Similarly, a payment application may be received from the device at the payment provider kiosk, wherein the payment application is used to generate the transaction.

The payment provider kiosk may provide a process to establish a payment account for the user with the payment provider to the communication device system. The approval may be determined by a merchant employee at or nearby the payment provider kiosk, wherein the merchant employee compares the at least one held item in a cart for the user to the at least selected item displayed on a device for the merchant employee. In other embodiments, approval may be determined by a device at the payment provider kiosk, wherein the device determines the approval by comprising a weight of the at least one held item in a cart for the user to an expected weight of the at least one selected item in the transaction. In further embodiments, the approval may be determined by a device at the payment provider kiosk, wherein the device determines the approval by scanning an RFID tag for each of the at least one held item and comparing the RFID tag for each of the at least one held item to an RFID tag identifier for each of the at least one selected item in the transaction. One or more of the aforementioned processes may also be used together to determine the approval.

In response to matching the at least one held item to the at least one selected item, an approval of the transaction is received from the payment provider kiosk, at step 410. Additionally, in response to receiving the approval, the transaction may be processed using the payment provider. For example, transaction may be processed and a payment may be provided to the merchant using a payment account of the user with the payment provider. In various embodiments, an update for the transaction comprising at least one new item added to the transaction is received, and the update is provided to the payment provider kiosk for updating the transaction. Thus, the approval may be further for the update for the transaction.

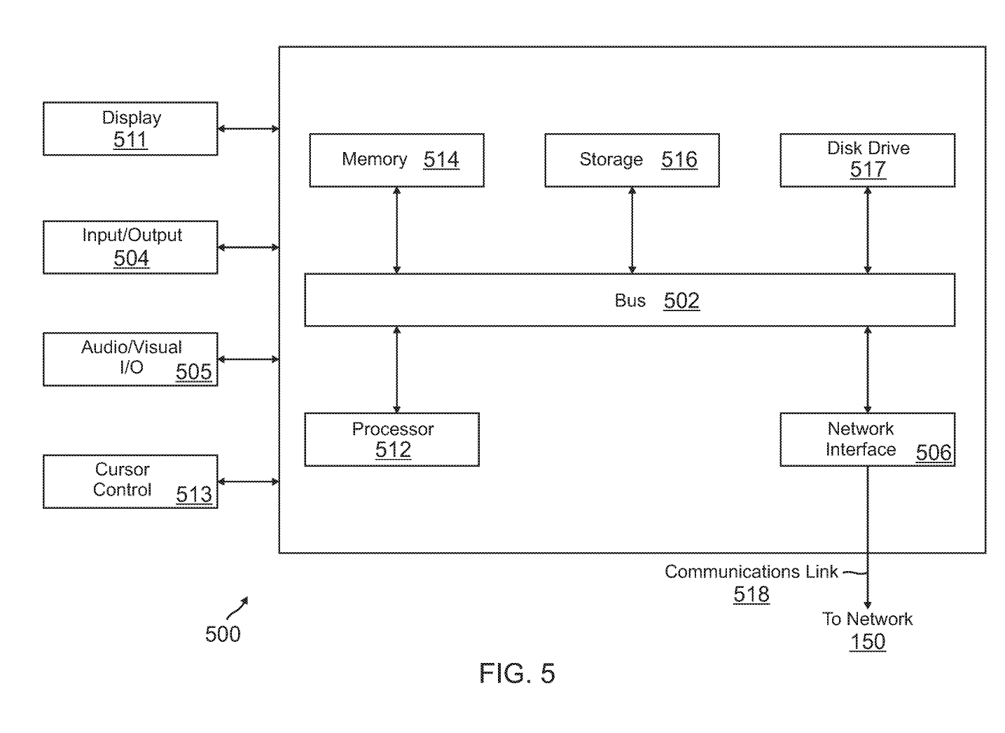

FIG. 5 is a block diagram of a computer system suitable for implementing one or more components in FIG. 1, according to an embodiment. In various embodiments, the payment card may comprise a contactless smart card providing a controller, a memory and an antenna capable of transferring and receiving data using a near field communications capability for communication with wireless beacons or other wireless protocol devices (e.g., a smart phone). The merchant and/or payment service provider may utilize a network computing device (e.g., a network server) capable of communicating with the network. It should be appreciated that each of the devices utilized by users, merchants and payment service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A communication device system comprising:
a non-transitory memory storing item information for at least one selected item for purchase by a user from a merchant at a physical merchant location for the merchant; and
one or more hardware processors coupled to the non-transitory memory and configured to read instructions from the non-transitory memory to cause the system to perform operations comprising:
receiving a request to generate a transaction for the at least one selected item from the user, wherein the request comprises the item information;
determining merchant information for the merchant;
in response to the request, generating the transaction for the at least one selected item using the merchant information and the item information;
providing the transaction for review at a payment provider kiosk located at the physical merchant location for the payment provider, wherein the review at the payment provider kiosk matches at least one held item in possession of the user at the payment provider kiosk to the at least one selected item in the transaction;
in response to matching the at least one held item to the at least one selected item, receiving an approval of the transaction from the payment provider kiosk.

2. The system of claim 1, wherein the one or more hardware processors are further configured to read instructions from the non-transitory memory to cause the system to perform further operations comprising:
in response to receiving the approval, processing the transaction using the payment provider.

3. The system of claim 2, wherein the transaction is processed and a payment is provided to the merchant using a payment account of the user with the payment provider.

4. The system of claim 1, wherein the communication device system provides the transaction to a device at the payment provider kiosk using short range wireless communications comprising one of near field communication, Bluetooth communication, Bluetooth Low Energy (BLE) communication, WiFi communication, and LTE Direct communication.

5. The system of claim 4, wherein the determining the merchant information comprises retrieving the merchant information from the device at the payment provider using the short range wireless communications.

6. The system of claim 4, wherein the one or more hardware processors are further configured to read instructions from the non-transitory memory to cause the system to perform further operations comprising:
receiving a payment application from the device at the payment provider kiosk, wherein the payment application is used to generate the transaction.

7. The system of claim 1, wherein the determining the merchant information comprises receiving a merchant identifier for the merchant from the user and retrieving the merchant information using the merchant identifier.

8. The system of claim 1, wherein the determining the merchant information comprises determining a geo-location for the user using a GPS locator for the communication device system and retrieving the merchant information using the geo-location of the user.

9. The system of claim 1, wherein the at least one selected item for purchase is selected through scanning a code for each of the at least one selected item using a camera of communication device system.

10. The system of claim 1, wherein the at least one selected item for purchase is selected through a menu selection of each of the at least one selected item through a mobile application executing on the communication device system.

11. The system of claim 1, wherein the at least one selected item for purchase is selected through entry of an item identifier for each of the at least one selected item, wherein the item identifier is associated with the at least one selected item at the merchant location.

12. The system of claim 1, wherein the one or more hardware processors are further configured to read instructions from the non-transitory memory to cause the system to perform further operations comprising:
receiving an update for the transaction comprising at least one new item added to the transaction; and
providing the update to the payment provider kiosk for updating the transaction.

13. The system of claim 12, wherein the approval is further for the update for the transaction.

14. A method comprising:
receiving, by a communication device system that comprises one or more hardware processors coupled to a non-transitory memory, a request to generate a transaction for at least one selected item from a user, wherein the request comprises item information for the at least one selected item for purchase by the user from a merchant at a physical merchant location for the merchant;
determining merchant information for the merchant;
in response to the request, generating the transaction for the at least one selected item using the merchant information and the item information;
providing the transaction for review at a payment provider kiosk located at the physical merchant location for the payment provider, wherein the review at the payment provider kiosk matches at least one held item in possession of the user at the payment provider kiosk to the at least one selected item in the transaction;
in response to matching the at least one held item to the at least one selected item, receiving an approval of the transaction from the payment provider kiosk.

15. The method of claim 14, wherein the payment provider kiosk provides a process to establish a payment account for the user with the payment provider to the communication device system.

16. The method of claim 14, wherein the approval is determined by a merchant employee at or nearby the payment provider kiosk, and wherein the merchant employee compares the at least one held item in a cart for the user to the at least selected item displayed on a device for the merchant employee.

17. The method of claim 14, wherein the approval is determined by a device at the payment provider kiosk, and wherein the device determines the approval by comprising a weight of the at least one held item in a cart for the user to an expected weight of the at least one selected item in the transaction.

18. The method of claim 14, approval is determined by a device at the payment provider kiosk, and wherein the device determines the approval by scanning an RFID tag for each of the at least one held item and comparing the RFID tag for each of the at least one held item to an RFID tag identifier for each of the at least one selected item in the transaction.

19. The method of claim 14, further comprising:
determining at least one discount for the transaction using merchant discount information for the merchant and user benefits stored to a digital wallet of the user with the payment provider; and
applying the at least one discount to the transaction prior to payment processing for the transaction at the payment provider kiosk.

20. A non-transitory machine-readable medium having stored thereon machine-readable instructions executable to cause a machine to perform operations comprising:
receiving, by a communication device system that comprises one or more hardware processors coupled to a non-transitory memory, a request to generate a transaction for at least one selected item from a user, wherein the request comprises item information for the at least one selected item for purchase by the user from a merchant at a physical merchant location for the merchant;
determining merchant information for the merchant;
in response to the request, generating the transaction for the at least one selected item using the merchant information and the item information;
providing the transaction for review at a payment provider kiosk located at the physical merchant location for the payment provider, wherein the review at the payment provider kiosk matches at least one held item in possession of the user at the payment provider kiosk to the at least one selected item in the transaction;
in response to matching the at least one held item to the at least one selected item, receiving an approval of the transaction from the payment provider kiosk.
